(19) United States
(12) Patent Application Publication
(10) Pub. No.: US 2015/0180311 A1
(43) Pub. Date: Jun. 25, 2015

(54) MOTOR CONTROLLER WITH COOLING FUNCTION AND COOLING METHOD FOR COOLING A MOTOR CONTROLLER

(71) Applicant: INDUSTRIAL TECHNOLOGY RESEARCH INSTITUTE, Hsinchu (TW)

(72) Inventors: Kou-Tzeng LIN, Hsinchu (TW); Li-Fen LIU, Hsinchu (TW); Min-Chuan WU, Hsinchu (TW); An-Hung LIN, Hsinchu (TW); Shin-Hung CHANG, Hsinchu (TW); Po-Hua CHANG, Hsinchu (TW)

(73) Assignee: INDUSTRIAL TECHNOLOGY RESEARCH INSTITUTE, Hsinchu (TW)

(21) Appl. No.: 14/519,046

(22) Filed: Oct. 20, 2014

(30) Foreign Application Priority Data
Dec. 20, 2013 (TW) 102147403

(51) Int. Cl. H02K 9/02; H02K 11/00; H02K 9/22

(52) U.S. Cl. CPC H02K 9/02; H02K 9/22; H02K 11/0073

(57) ABSTRACT

A motor controller and a cooling method thereof are provided. The motor controller includes: a first power module; a second power module; a first heat sink having first fins; a second heat sink having second fins; a first partition board; a second partition board; a housing disposed at external sides of the first and second partition boards, with a first channel formed between the housing and the first partition board; a conduit connected to a rear end of the first heat sink and extending to an outlet of the housing; a first flow channel; and a second flow channel passing through the first channel and the gaps of the second fins, for second cold air to be introduced, and processed by a heat exchange process performed by the second power module to generate second hot air that is expelled to the outlet of the housing through the second flow channel.

### CROSS-REFERENCE TO RELATED APPLICATIONS

This application claims priority to Taiwanese Patent Application No. 102147403, filed on Dec. 20, 2013. The entirety of the above-mentioned patent application is hereby incorporated by reference herein and made a part of this specification.

### BACKGROUND

1. Technical Field

The present disclosure relates to motor controllers, and, more particularly, to a motor controller with a cooling function and a cooling method for cooling a motor controller.

2. Description of Related Art

Typically, an electric vehicle uses electric power to drive a motor to drive the vehicle to move. The rotation of the motor requires a motor controller to control so that various requirements of power take-off can be reached. However, the motor controller generates considerable heat during the control process, and the heat has to be appropriately removed to keep the motor controller in normal operation.

Moreover, the motor controller has various power elements or chips. If a conventional cooling method is applied, temperature unevenness may occur between each power element, such that the power element with high temperature may be damaged early which causes the performance of the motor controller to decrease and even malfunction.

FIG. 1A illustrates a top view of a motor controller 1 according to the prior art. FIG. 1B illustrates a cross-sectional view of the motor controller 1 according to the prior art along a line S1 of FIG. 1A.

The motor controller 1 comprises a first power module 10, a second power module 11, a first heat sink 12, a second heat sink 13, a housing 14, and a flow channel 15.

The first power module 10 is connected in series with the second power module 11 by a connection 16. The first power module 10 has a plurality of chips 101. the second power module 11 also has a plurality of chips 111.

The first heat sink 12 and the second heat sink 13 are disposed on the first power module 10 and the second power module 11, respectively, and have a plurality of respective first fins 121 and second fins 131.

The housing 14 is disposed at external sides of the first heat sink 12 and the second heat sink 13, and a channel 143 is formed between the first heat sink 12 and the second heat sink 13.

The flow channel 15 passes the channel 143, gaps 122 of the first fins 121, and gaps of the second fins 131 sequentially. Cold air A1 introduced from an inlet of the housing 14 passes a front end of the channel 143 and the gaps 122 of the first fins 121, and first hot air A2 is generated by processing the cold air A1 with a heat exchange process performed by the first fins 121 and the first power module 10.

The first hot air A2 passes a rear end of the channel 143 and the gaps of the second fins 131, and generates second hot air A3 by proceeding heat exchange with the second fins 131 and the second power module 11. The second hot air A3 will be expelled to a region outside of the outlet 142 of the housing 14.

Since the second power module 11 uses the first hot air A2, rather than the cold air Al, to proceed heat exchange, the temperature of the second power module 11 and the second hot air A3 will be higher than that of the first power module 10 and the first hot air A2, resulting in an temperature unevenness between the first power module 10 and the second power module 11.

FIGS. 2A, 2B and 2C illustrate the analysis model chart, flow field distribution chart, and temperature distribution chart of the motor controller 1 according to the prior art. FIG. 3 shows a table of the highest temperature of each chip of the motor controller 1 according to the prior art.

As illustrated in FIG. 2C, a first power module 10 and a second power module 11 have a total of 12 chips. The first power module 10 has a total of 6 chips including first diode D1 to third diode D3 and first insulated gate bipolar transistor I1 to third insulated gate bipolar transistor 13. The second power module 11 has a total of 6 chips including fourth diode D4 to sixth diode D6 and fourth insulated gate bipolar transistor 14 to sixth insulated gate bipolar transistor 16.

The cooling condition of the motor controller 1 comprises: the flowrate of the cold air A1 is 1.927 m³/min, the temperature of air at the inlet 141 is 40° C., the generated thermal energy of each diode is 41.6W, the generated thermal energy of each insulated gate bipolar transistor is 125W, and the total thermal energy of the entire motor controller 1 is 1,000W.

As illustrated in FIG. 3, based on the abovementioned cooling condition, the temperature of the 12 chips is between 172.4° C. and 221.8° C., and the temperature unevenness is 49.4° C. Therefore, the temperature unevenness of the chip of the motor controller according to the prior art is high, such that each chip is tended to be damaged early, causing the performance of the motor controller 1 decrease and even malfunction.

Thus, how to overcome the abovementioned problems of the prior art is an technical issue desired to be solved.

### SUMMARY

The present disclosure provides a motor controller with a cooling function, comprising: a first power module; a second power module arranged in series with the first power module; a first heat sink disposed on the first power module and having a plurality of first fins; a second heat sink disposed on the second power module and having a plurality of second fins; a first partition board disposed on the first fins; a second partition board disposed on the second fins; a housing disposed at external sides of the first and second partition boards, with a first channel formed between the housing and the first partition board; a conduit connected to a rear end of the first heat sink and extending to an outlet of the housing; a first flow channel passing through gaps of the first fins and the conduit sequentially, for first cold air to be introduced therein, and processed by a heat exchange process performed by the first power module to generate first hot air that is expelled to a region outside of the outlet of the housing through the first flow channel; and a second flow channel passing through the first channel and gaps of the second fins sequentially, for second cold air to be introduced therein, and processed by a heat exchange process performed by the second power module to generate second hot air that is expelled to a region outside of the outlet of the housing through the second flow channel.

The present disclosure further provides a method for cooling a motor controller, comprising: introducing first cold air through gaps of the first fins and a first flow channel in the conduit sequentially, such that the first cold air is processed by a heat exchange process performed by the first power module to generate first hot air that is expelled to the outlet of the housing through the first flow channel; and introducing second cold air through the first channel and a second flow channel of gaps of the second fins sequentially, such that the second cold air is processed by a heat exchange process performed by the second power module to generate second hot air that is expelled to the outlet of the housing through the second flow channel.

### BRIEF DESCRIPTION OF DRAWINGS

The patent or application file contains at least one sheet of drawings executed in color. Copies of this patent or patent application publication with color drawing will be provided by the Office upon request and payment of the necessary fee.

FIG. 1A illustrates a top view of a motor controller according to the prior art;

FIG. 1B illustrates a cross-sectional view of the motor controller according to the prior art along a line S1 of FIG. 1A;

FIGS. 2A, 2B and 2C illustrate an analysis model diagram, flow field distribution diagram, and temperature distribution diagram of the motor controller according to the prior art, respectively;

FIG. 3 shows a table of the highest temperature of each chip of the motor controller according to the prior art;

FIG. 4 illustrates a three-dimensional diagram of a portion of a motor controller with a cooling function according to the present disclosure;

FIG. 5A illustrates a top view of a motor controller according to the present disclosure;

FIG. 5B illustrates a cross-sectional view of the motor controller according to the present disclosure along a line S2 of FIG. 5A;

FIGS. 6A, 6B and 6C illustrate an analysis model diagram, flow field distribution diagram, and temperature distribution diagram of the motor controller with a cooling function according to the present disclosure, respectively; and

FIG. 7 shows a table of the highest temperature of each chip of the motor controller with a cooling function according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

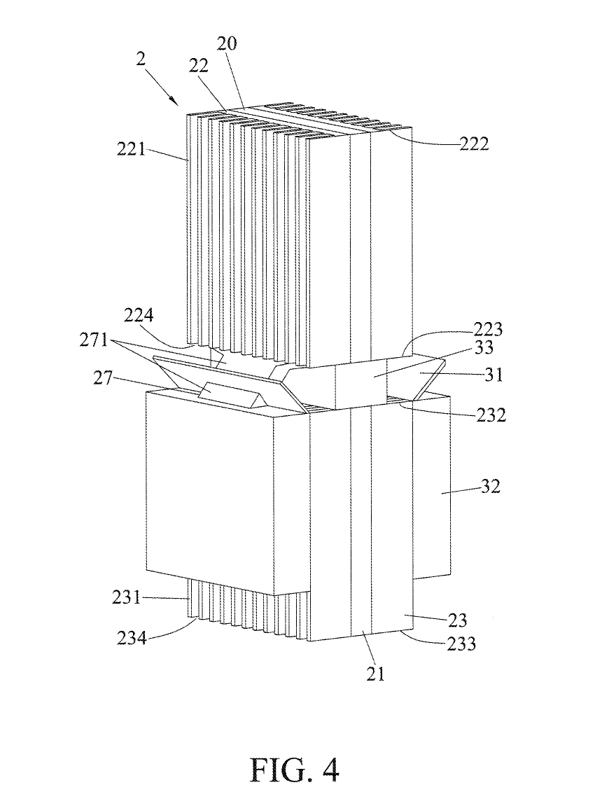

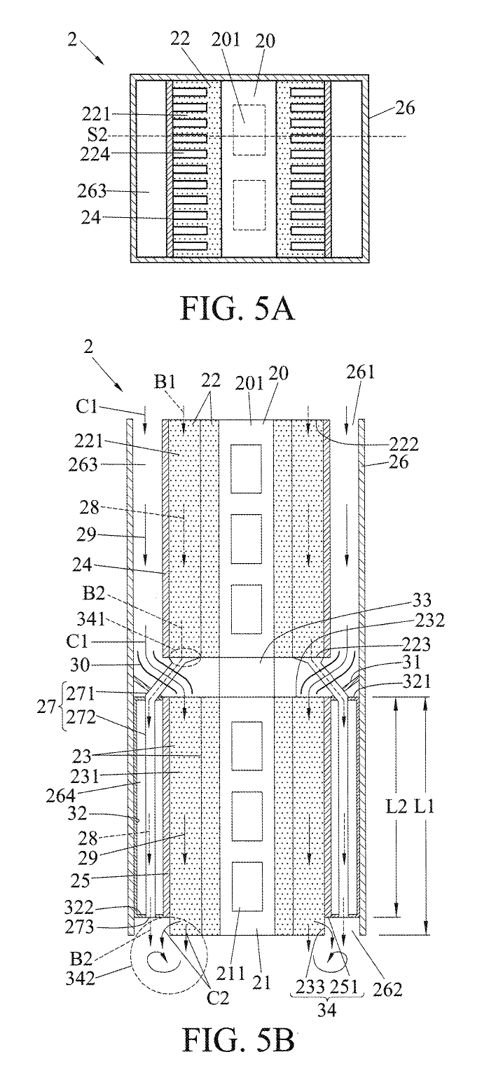

FIG. 4 illustrates a three-dimensional diagram of a portion of a motor controller 2 with a cooling function according to the present disclosure. FIG. 5A illustrates a top view of the motor controller 2 according to the present disclosure. FIG. 5B illustrates a cross-sectional view of the motor controller 2 according to the present disclosure along a line S2 of FIG. 5A.

As illustrated in FIGS. 4, 5A and 5B, the motor controller 2 comprises a first power module 20, a second power module 21, a first heat sink 22, a second heat sink 23, a first partition board 24, a second partition board 25, a housing 26, a conduit 27, a first flow channel 28, and a second flow channel 29.

The first power module 20 is connected in series with the second power module 21 by a connection 33. The first power module 20 has a plurality of chips 201. The second power module 21 has a plurality of chips 211.

The first heat sink 22 and the second heat sink 23 are disposed on the first power module 20 and the second power module 21, respectively, and have a plurality of first fins 221 and a plurality of second fins 231, respectively. The first fin 221 has a front end 222 and a rear end 223. The second fin 231 has a front end 232 and a rear end 233.

The first partition board 24 and the second partition board 25 are disposed on the first fins 221 and the second fins 231, respectively. The housing 26 is disposed at external sides of the first partition board 24 and the second partition board 25. A first channel 263 is formed between the housing 26 and the first partition board 24. A second channel 264 is formed between the housing 26 and the second partition board 25. The conduit 27 is connected to the rear end 223 of the first heat sink 22 and extends to a region adjacent to an outlet 262 of the housing 26.

The first flow channel 28 passes through first gaps 224 of the first fins 221 and the conduit 27 sequentially. First cold air B1 is introduced from the front end 222 of the first fins 221 into the first gaps 224 of the first fins 221, and processed by a heat exchange process performed by the first power module 20 and chips 201 thereof through the first fins 221 to generate first hot air B2 that is expelled to the outlet 262 of the housing 26 through the first flow channel 28.

The second flow channel 29 passes through the first channels 263 and second gaps 234 of the second fins 231 sequentially. Second cold air C1 is introduced from an inlet 261 of the housing 26 into the first channel 263, and processed by a heat exchange process performed by the second power module 21 and chips 211 thereof through the second fins 231 to generate second hot air C2 that is expelled to the outlet 262 of the housing 26 through the second flow channel 29.

The motor controller 2 comprises at least one curve air deflector 30 disposed between the first partition board 24 and the second partition board 25, and/or between the first channel 263 and the second channel 264, so as to deflect the second cold air C1 from the first channel 263 to the second gaps 234 of the second fins 231.

The motor controller 2 further comprises an inclined partition board 31 that has two ends connected to the second partition board 25 and the housing 26, respectively, so as to deflect the second cold air C1 from the first channel 263 to the second gaps 234 of the second fins 231.

The conduit 27 has an oblique tube 271 and a straight tube 272 connected with the oblique tube 271. The oblique tube 271 passes obliquely from the rear end 223 of the first heat sink 22 through the inclined partition board 31 and extends to the second channel 264. The straight tube 272 is disposed in the second channel 264 and extends to a region adjacent to the outlet 262 of the housing 26.

The motor controller 2 may comprise an inverted U-shaped cap 32 covering the straight tube 272, with the outlet 273 of the straight tube 272 exposed therefrom. The cap 32 closes the second channel 264 to prevent the second cold air C1 from flowing into the second channel 264.

The cap 32 may be replaced with a first board 321 and/or a second board 322. The first board 321 is disposed at the upper end of the straight tube 272, so as to close the flow channel at the upper end of the second channel 264 and prevent the second cold air C1 from flowing into the second channel 264. The second board 322 is disposed at the lower end of the straight tube 272, so as to close the flow channel at the lower end of the second channel 264 and prevent the second cold air C1 from flowing into the second channel 264.

The length L1 of the second fins 231 may be greater than the length L2 of the second partition board 25, such that a step portion 34 is formed between the rear ends 233 of the second fins 231 and the rear end 251 of the second partition board 25. When the first hot air B2 flows to the outlet 273 of the straight tube 272 of the conduit 27 from the rear ends 223 of the first fins 221, the rear ends 223 of the first fins 221 form a positive pressure section 341, and the step portion 34 forms a reverse flow section 342 having a negative pressure, such that the first hot air B2 flows from the positive pressure section 341 to the reverse flow section 342 having the negative pressure to outflow from the outlet 262 of the housing 26.

As illustrated in FIG. 5B, in accordance to a method for cooling the motor controller 2 of the present disclosure, the method comprises providing a motor controller 2 comprising a first power module 20, a second power module 21, a first heat sink 22, a second heat sink 23, a first partition board 24, a second partition board 25, a housing 26, and a conduit 27. The first power module 20 is arranged in series with the second power module 21. The first heat sink 22 and the second heat sink 23 are disposed on the first power module 20 and the second power module 21, respectively. The first heat sink 22 has a plurality of first fins 221. The second heat sink 23 has a plurality of second fins 231. The first partition board 24 and the second partition board 25 are disposed on the first fins 221 and the second fins 231, respectively. The housing 26 is disposed at external walls of the first partition board 24 and the second partition board 25, and a first channel 263 is formed between the housing 26 and the first partition board 24. The conduit 27 is connected to the rear end 223 of the first heat sink 22 and extends to a region adjacent to the outlet 262 of the housing 26.

According to the method, first cold air B1 (or a portion of cold air) may then be introduced to pass through the first gaps 224 of the first fins 221 (as shown in FIG. 4) and a first flow channel 28 in the conduit 27 sequentially, such that the first cold air B1 is processed by a heat exchange process performed by the first power module 20 and chips 201 thereof to generate first hot air B2 that is expelled to the outlet 262 of the housing 26 through the first flow channel 28.

Also, second cold air C1 (or another portion of cold air) may be introduced to pass through the first channel 263 and the second flow channel 29 of the second gaps 234 of the second fins 231 (as shown in FIG. 4) sequentially, such that the second cold air C1 is processed by a heat exchange process performed by the second power module 21 and the second fins 231 to generate second hot air C2 that is expelled to the outlet 262 of the housing 26 through the second flow channel 29.

The method further comprises disposing at least one curve air deflector 30 between the first partition board 24 and the second partition board 25 and/or between the first channel 263 and second channel 264, so as to deflect the second cold air C1 from the first channel 263 to the gaps 234 of the second fins 231.

The method further comprises connecting two ends of an inclined partition board 31 to the second partition board 25 and the housing 26, respectively, so as to deflect the second cold air C1 from the first channel 263 to the second gaps 234 of the second fins 231.

The method further comprises disposing an inverted U-shaped cap 32 covering the straight tube 272 of the conduit 27, with the outlet 273 of the straight tube 272 exposed therefrom, and closing the second channel 264 to prevent the second cold air C1 from flowing into the second channel 264.

The method further comprises replacing the cap 32 by a first board 321 and/or a second board 322, disposing the first board 321 at the upper end of the straight tube 272 of the conduit 27s to close the flow channel at the upper end of the second channel 264 and prevent the second cold air C1 from flowing into the second channel 264, and disposing the second board 322 at the lower end of the straight tube 272 of the conduit 27 to close the flow channel at the upper end of the second channel 264 and prevent the second cold air C1 from flowing into the second channel 264.

The method further comprises forming a step portion 34 by the rear ends 251 of the second fins 231 and the rear end 251 of the second partition board 25. When the first hot air B2 flows to the outlet 273 of the straight tube 272 of the conduit 27 from rear ends 223 of the first fins 221, the rear ends 223 of the first fins 221 form a positive pressure section 341, and the step portion 34 forms a reverse flow section 342 having a negative pressure, such that the first hot air B2 flows from the positive pressure section 341 to the reverse flow section 342 having the negative pressure.

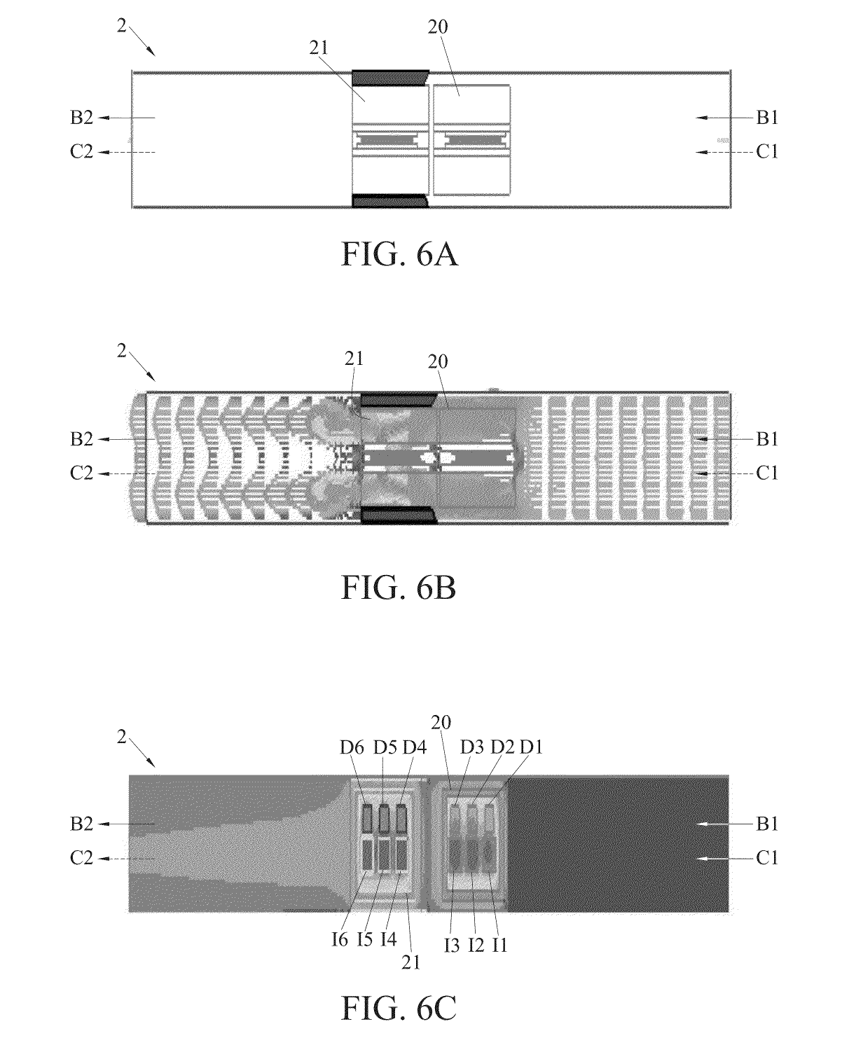

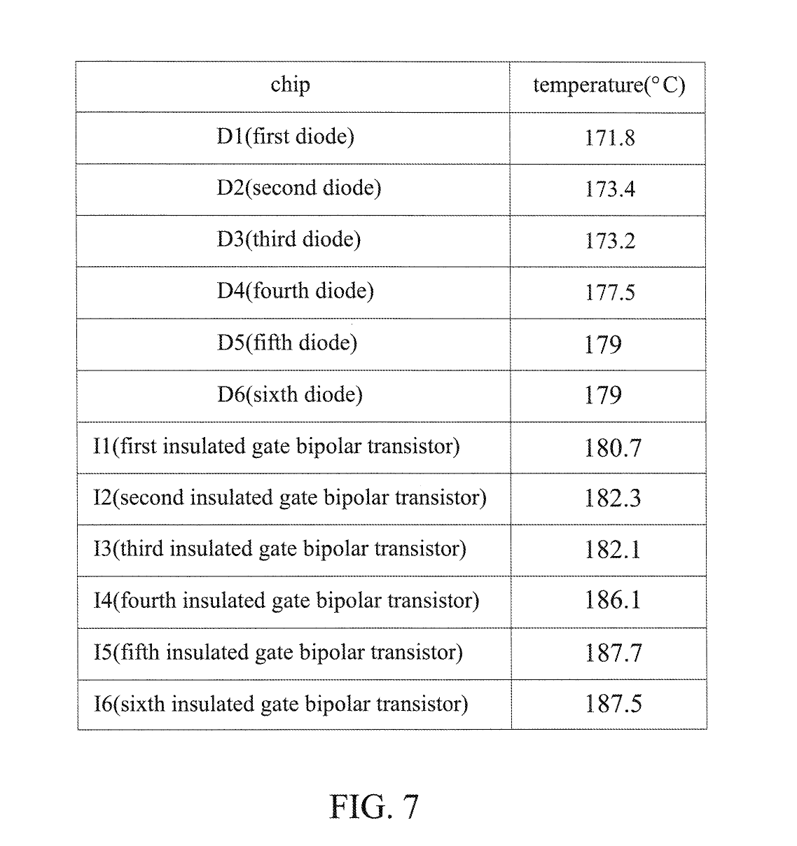

FIGS. 6A, 6B and 6C illustrate an analysis model diagram, flow field distribution diagram, and temperature distribution diagram of the motor controller 2 with a cooling function according to the present disclosure, respectively. FIG. 7 shows a table of the highest temperature of each chip of the motor controller 2 with a cooling function according to the present disclosure.

As illustrated in FIG. 6C, a first power module 20 and a second power module 21 have a total of 12 chips. The first power module 20 has a total of 6 chips including first diode D1 to third diode D3 and first insulated gate bipolar transistor I1 to third insulated gate bipolar transistor 13. The second power module 21 has a total of 6 chips including fourth diode D4 to sixth diode D6 and fourth insulated gate bipolar transistor 14 to sixth insulated gate bipolar transistor 16.

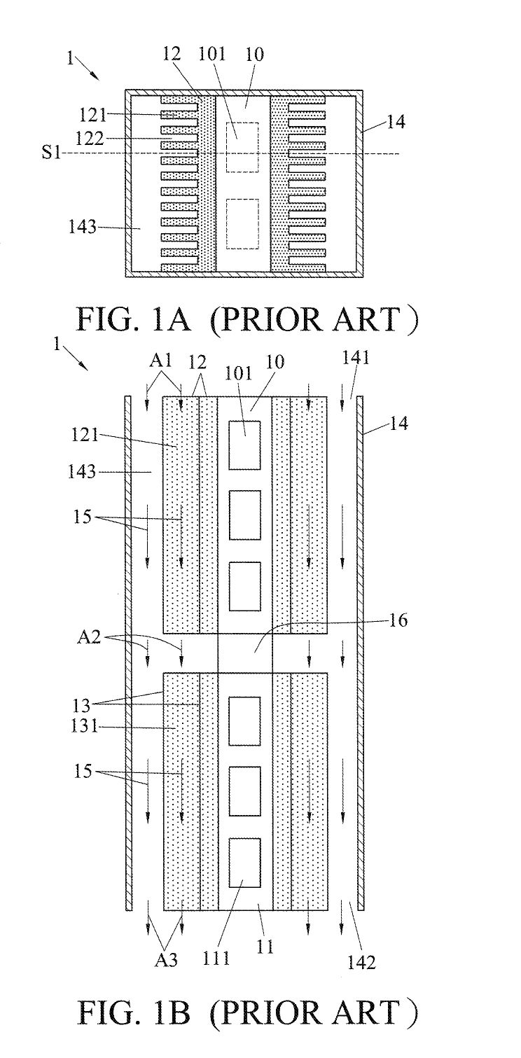

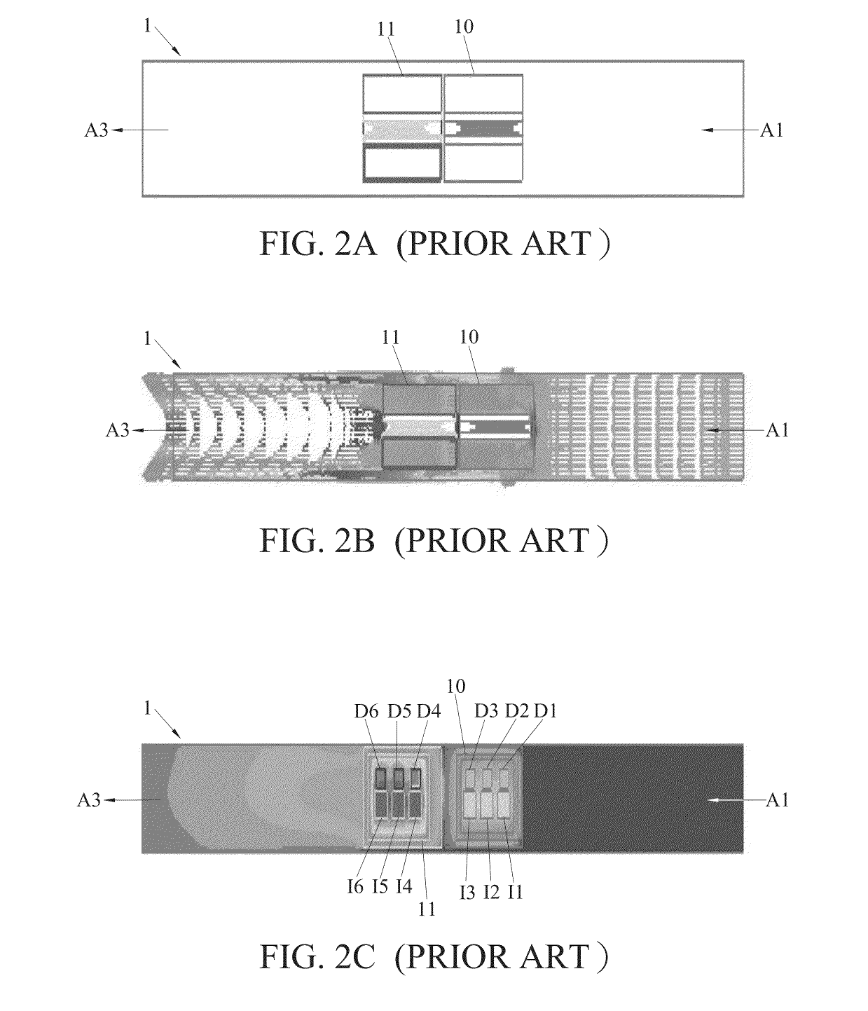

The cooling condition of the motor controller 2 as shown in FIGS. 4, 5A and 5B is identical with that of the motor controller 1 as shown in FIGS. 1A and 1B, that is: the flowrate of first cold air B1 and second cold air C1 is 1.927 m³/min, the temperature of air at the inlet 261 is 40° C., the generated thermal energy of each diode is 41.6W, the generated thermal energy of each insulated gate bipolar transistor is 125W, and the total thermal energy of the entire motor controller 2 is 1,000W.

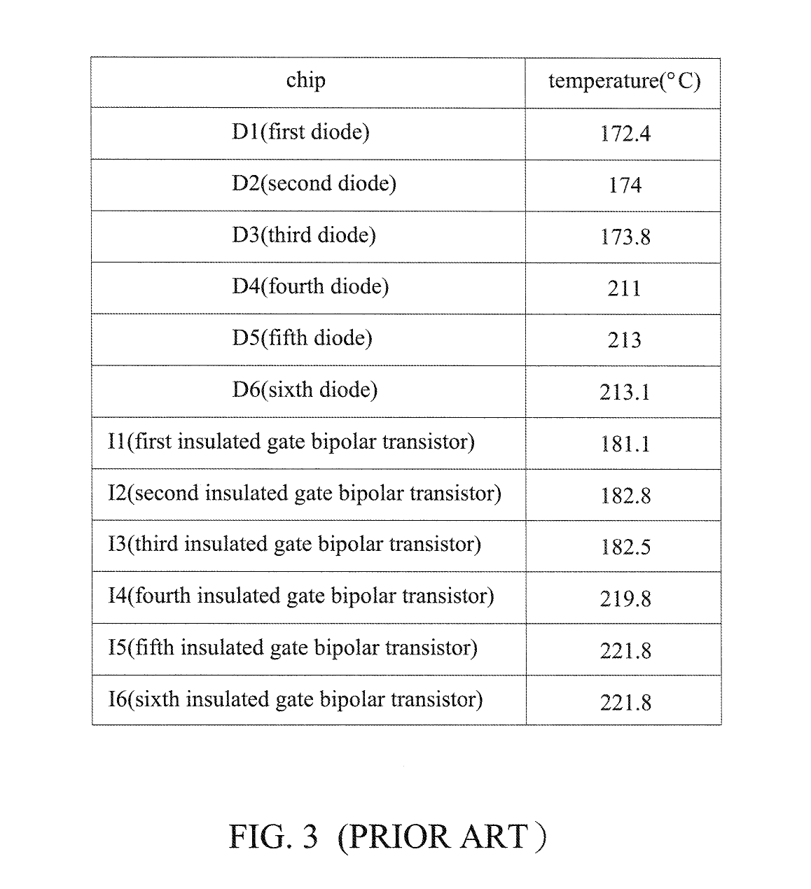

As illustrated in FIG. 7, based on the above cooling condition, the temperature of the 12 chips is between 171.8° C. and 187.7° C., and the temperature unevenness is 15.9° C. By contrast, the temperature of the 12 chips of FIG. 3 according to the prior art is between 172.4° C. and 221.8° C., and the temperature unevenness is 49.4° C. The temperature of the 6 chips of the second power module 21 of the present disclosure is lower than 188° C., such that the chips are more durable under long operation. However, the temperature of the 6 chips of the second power module 11 of the prior art is higher than 210° C., such that the chips are tended to be damaged under long operation. Therefore, the motor controller of FIGS. 4, 5A and 5B of the present disclosure significantly has better temperature evenness and heat dissipation compared with the motor controller 1 of FIGS. 1A and 1B of the prior art.

In accordance with the above description, it can be seen that the present disclosure provides a motor controller with a cooling function and cooling method thereof. The present disclosure is achieved mainly by disposing elements such as a first partition board, a second partition board, and a conduit in the motor controller, so as to introduce first cold air into a first flow channel such that the first cold air is processed by a heat exchange process performed by a first power module to expel first hot air to the outlet of the housing, and to introduce second cold air into a second flow channel such that the second cold air is processed by a heat exchange process performed by a second power module to expel second hot air to the outlet of the housing.

Therefore, the present disclosure allows the first power module and the second power module to achieve even temperature distribution and high cooling effect, and reduces the damage caused by the temperature difference between the first power module and the second power module, such that the motor controller achieves good operation performance and reduce the occurrence of malfunction.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A motor controller with a cooling function, comprising:
a first power module;
a second power module arranged in series with the first power module;
a first heat sink disposed on the first power module and having a plurality of first fins;
a second heat sink disposed on the second power module and having a plurality of second fins;
a first partition board disposed on the first fins;
a second partition board disposed on the second fins;
a housing disposed at external sides of the first and second partition boards, with a first channel formed between the housing and the first partition board;
a conduit connected to a rear end of the first heat sink and extending to an outlet of the housing;
a first flow channel passing through gaps of the first fins and the conduit sequentially, for first cold air to be introduced therein, and processed by a heat exchange process performed by the first power module to generate first hot air that is expelled to a region outside of the outlet of the housing through the first flow channel; and
a second flow channel passing through the first channel and gaps of the second fins sequentially, for second cold air to be introduced therein, and processed by a heat exchange process performed by the second power module to generate second hot air that is expelled to a region outside of the outlet of the housing through the second flow channel.

2. The motor controller of claim 1, further comprising at least one curve air deflector disposed between the first partition board and the second partition board for deflecting the second cold air from the first channel to the gaps of the second fins.

3. The motor controller of claim 1, further comprising an inclined partition board having two ends connected to the second partition board and the housing, respectively, for deflecting the second cold air from the first channel to the gaps of the second fins.

4. The motor controller of claim 3, wherein a second channel is formed between the second partition board and the housing, and the conduit has an oblique tube obliquely passing through the inclined partition board from the rear end of the first sink and extending to the second channel, and a straight tube connected to the oblique tube, disposed in the second channel and extending to the outlet of the housing.

5. The motor controller of claim 4, further comprising a cap covering the straight tube, with an outlet of the straight tube exposed therefrom, and closing the second channel to prevent the second cold air from flowing into the second channel.

6. The motor controller of claim 4, further comprising a first board disposed at an upper end of the straight tube to close a flow channel at an upper end of the second channel and prevent the second cold air from flowing into the second channel.

7. The motor controller of claim 4, further comprising a second board disposed at a lower end of the straight tube to close a flow channel at a lower end of the second channel and prevent the second cold air from flowing into the second channel.

8. The motor controller of claim 1, wherein the second fins are longer than the second partition board, and a step portion is formed between rear ends of the second fins and a rear end of the second partition board.

9. The motor controller of claim 8, wherein when the first hot air flows to an outlet of the conduit from rear ends of the first fins, the rear ends of the first fins form a positive pressure section, and the step portion forms a reverse flow section having a negative pressure, such that the first hot air flows from the positive pressure section to the reverse flow section having the negative pressure.

10. A method for cooling a motor controller, comprising:
introducing first cold air through gaps of a plurality of first fins and a first flow channel in a conduit sequentially, such that the first cold air is processed by a heat exchange process performed by a first power module to generate first hot air that is expelled to an outlet of a housing through a first flow channel; and
introducing second cold air through a first channel and a second flow channel of gaps of a plurality of second fins sequentially, such that the second cold air is processed by a heat exchange process performed by a second power module to generate second hot air that is expelled to the outlet of the housing through a second flow channel.

11. The method of claim 10, further comprising:
providing a motor controller comprising the first power module, the second power module arranged in series with the first power module, a first heat sink disposed on the first power module and having the first fins, a second heat sink disposed on the second power module and having the second fins, a first partition board disposed on the first fins, a second partition board disposed on the second fins, the housing disposed at external sides of the first and second partition boards, with the first channel formed between the housing and the first partition board, and the conduit connected to a rear end of the first heat sink and extending to the outlet of the housing; and
disposing at least one curve air deflector between the first partition board and the second partition board, for deflecting the second cold air from the first channel to the gaps of the second fins.

12. The method of claim 10, further comprising connecting two ends of an inclined partition board to the second partition board and the housing, respectively, for deflecting the second cold air from the first channel to the gaps of the second fins.

13. The method of claim 10, further comprising disposing a cap covering a straight tube of the conduit, with an outlet of the straight tube exposed therefrom, and closing the second channel to prevent the second cold air from flowing into the second channel.

14. The method of claim 10, further comprising disposing a first board at an upper end of a straight tube of the conduit, so as to close the flow channel at an upper end of the second channel and prevent the second cold air from flowing into the second channel.

15. The method of claim 10, further comprising disposing a second board at a lower end of a straight tube of the conduct, so as to close the flow channel at a lower end of the second channel and prevent the second cold air from flowing into the second channel.

16. The method of claim 10, further comprising forming a step portion by rear ends of the second fins and a rear end of the second partition board, wherein when the first hot air flows to the outlet of the conduit from rear ends of the first fins, the rear ends of the first fins form a positive pressure section, and the step portion forms a reverse flow section having a negative pressure, such that the first hot air flows from the positive pressure section to the reverse flow section having the negative pressure.
